(19) United States
(12) Patent Application Publication
(10) Pub. No.: US 2010/0245423 A1
(43) Pub. Date: Sep. 30, 2010

(54) DROPLET EJECTING HEAD AND IMAGE FORMING DEVICE

(76) Inventor: Katsuto SUMI, Kanagawa (JP)

Correspondence Address: BIRCH STEWART KOLASCH & BIRCH, PO BOX 747, FALLS CHURCH, VA, 22040-0747, US

(21) Appl. No.: 12/723,968

(22) Filed: Mar. 15, 2010

(30) Foreign Application Priority Data
Mar. 26, 2009 (JP) 2009-077514

(51) Int. Cl. B41J 29/38

(52) U.S. Cl. 347/10; 347/14

(57) ABSTRACT

There is provided a droplet ejecting head in which plural ejecting openings, that eject droplets onto a recording medium that is conveyed by a conveying unit that conveys the recording medium, are provided so as to be lined-up in a conveying direction of the recording medium onto which the droplets are ejected, and in an cross-conveying direction that crosses the conveying direction. The respective ejecting openings are arranged so as to become distances that are determined in accordance with timings at which the respective ejecting openings eject the droplets, an ejecting speed of the droplets, a conveying speed of the recording medium, and a radius of the drum, such that positions, in the conveying direction of the recording medium, at which the droplets ejected from the ejecting openings land, substantially coincide at all of the ejecting openings.

### CROSS-REFERENCE TO RELATED APPLICATION

This application is based on and claims priority under 35 USC 119 from Japanese Patent Application No. 2009-077514 filed on Mar. 26, 2009 which is incorporated by reference herein.

### BACKGROUND

1. Technical Field

The present invention relates to a droplet ejecting head and an image forming device, and in particular, relates to a droplet ejecting head and an image forming device that eject droplets onto a recording medium conveyed at a drum.

2. Related Art

In an image forming device that ejects droplets onto a recording medium conveyed at a drum, because the drum surface is a curved surface, errors arise in the landing positions of the droplets that are ejected from the droplet ejecting head. As a result, there are cases in which the linearity (raggedness) of linear images, that affects image quality, is deteriorated.

Thus, Japanese Patent Application Laid-Open (JP-A) No. 2006-327108 discloses a technique of forming an ejecting opening plate in the shape of a cylindrical tube, at liquid ejecting heads that are arrayed in the form of a two-dimensional matrix. Further, also disclosed is the technique of forming, in the shapes of cylindrical tubes, the substrate at which are formed the piezoelectric elements that generate the ejecting pressure, and the substrate at which are formed the driving wires for supplying driving signals to the piezoelectric elements.

However, forming an ejection surface, at which are provided ejecting openings that eject droplets, in the shape of a curved surface is very difficult from the standpoint of head manufacturing, and, further, leads to an increase in costs.

### SUMMARY

The present invention provides a droplet ejecting head and an image forming device that suppress offset in the landing positions of droplets, without forming an ejection surface in the shape of a curved surface.

An aspect of the present invention is a droplet ejecting head that ejects droplets onto a recording medium that is conveyed by a conveying unit that conveys the recording medium while causing the recording medium to closely contact a peripheral surface of a drum, the droplet ejecting head having: plural ejecting openings that are provided so as to be lined-up in a conveying direction of the recording medium onto which the droplets are ejected, and in an cross-conveying direction that crosses the conveying direction, wherein distances, in the conveying direction of the recording medium, of the respective ejecting openings are determined in accordance with timings at which the respective ejecting openings eject the droplets, an ejecting speed of the droplets, a conveying speed of the recording medium, and a radius of the drum, such that positions, in the conveying direction of the recording medium, at which the droplets ejected from the ejecting openings land, substantially coincide at all of the ejecting openings.

### BRIEF DESCRIPTION OF THE DRAWINGS

An exemplary embodiment of the present invention will be described in detail based on the following figures, wherein:

FIG. 1 is a side sectional view showing the structure of an image forming device relating to an exemplary embodiment;

FIG. 2 is a block diagram showing the system structure of the image forming device relating to the exemplary embodiment;

FIG. 3 is a transparent plan view showing a structural example of a head relating to the exemplary embodiment;

FIG. 4 is a drawing showing offset of landing positions;

FIG. 5 is a drawing showing the positional relationship between a head and a drum (part 1);

FIG. 6 is a drawing showing the positional relationship between the head and the drum (part 2);

FIG. 7 is a drawing showing the relationship between nozzle coordinates and position offset (part 1);

FIG. 8 is a drawing showing the relationship between the nozzle coordinates and position offset (part 2);

FIG. 9 is a drawing showing nozzle coordinate differences after correction;

FIG. 10 is a drawing showing nozzles arranged in a linear form, and respective nozzles arranged in accordance with distances Y′_{b}; and

FIG. 11 is a drawing showing the positional relationship between the head and the drum, before correction and after correction.

### DETAILED DESCRIPTION

Here, a case will be described in which the present invention is applied to a so-called inkjet printer (hereinafter called “image forming device”) that forms images by ink drops.

First, the overall structure of an image forming device 10 relating to the present exemplary embodiment will be described.

[Image Forming Device]

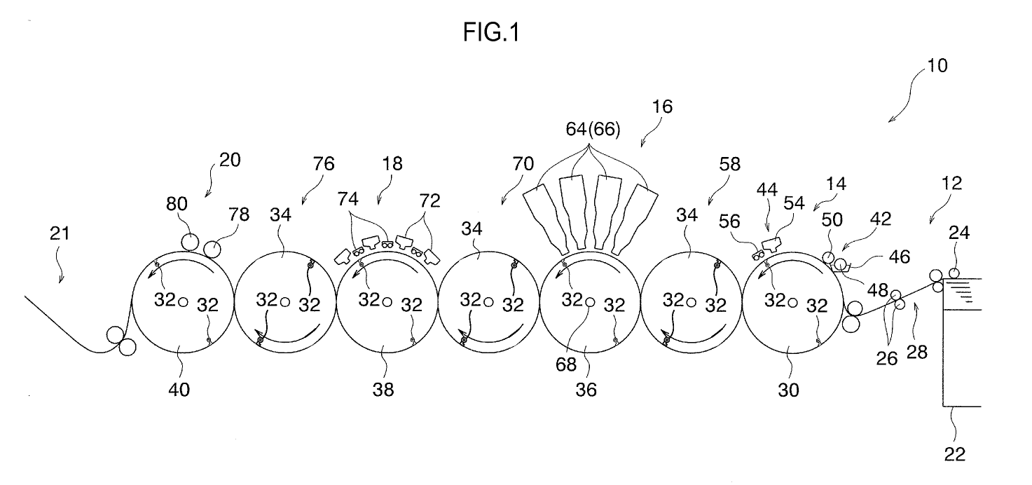

As shown in FIG. 1, a feeding/conveying section 12 that feeds and conveys sheets is provided at the image forming device 10 relating to the present exemplary embodiment, at the upstream side in the conveying direction of sheets that serve as recording media. Provided along the sheet conveying direction at the downstream side of the feeding/conveying section 12 are a processing liquid coating section 14, an image forming section 16, an ink drying section 18, an image fixing section 20, and a discharging section 21. The processing liquid coating section 14 coats a processing liquid on a recording surface (image forming surface) of the sheet. The image forming section 16 forms an image on the recording surface of the sheet. The ink drying section 18 dries the image formed on the recording surface. The image fixing section 20 fixes the dried image to the sheet. The discharging section 21 discharges the sheet on which the image is fixed.

The respective processing sections will be described hereinafter.

(Feeding/Conveying Section)

A stacking section 22 in which sheets are stacked is provided at the feeding/conveying section 12. A sheet feed portion 24, that feeds one-by-one the sheets that are stacked in the stacking section 22, is provided at the downstream side in the sheet conveying direction (hereinafter, “in the sheet conveying direction” may be omitted) of the stacking section 22. The sheet that is fed by the sheet feed portion 24 is conveyed to the processing liquid coating section 14 via a conveying portion 28 that is structured by plural roller 26 pairs.

(Processing Liquid Coating Section)

A processing liquid coating drum 30 is disposed at the processing liquid coating section 14 so as to be rotatable. Holding members 32, that nip the leading end portions of sheets and hold the sheets, are provided at the processing liquid coating drum 30. In the processing liquid coating section 14, in the state in which a sheet is held at the surface of the processing liquid coating drum 30 via the holding member 32, the sheet is conveyed to the downstream side by the rotation of the processing liquid coating drum 30.

Note that, in the same way as at the processing liquid coating drum 30, the holding member 32 are provided as well at intermediate conveying drums 34, an image forming drum 36, an ink drying drum 38 and a fixing drum 40 that will be described later. The transfer of a sheet from an upstream side drum to a downstream side drum is carried out by the holding members 32.

A processing liquid coating device 42 and a processing liquid drying device 44 are disposed along the peripheral direction of the processing liquid coating drum 30 at the upper portion of the processing liquid coating drum 30. The processing liquid coating device 42 coats processing liquid onto the recording surface of the sheet. The processing liquid drying device 44 dries this processing liquid.

Here, the processing liquid reacts with ink, aggregates the color material (pigment), and has the effect of promoting separation of the color material (pigment) and the solvent. A storing portion 46, in which the processing liquid is stored, is provided at the processing liquid coating device 42. A portion of a gravure roller 48 is soaked in the processing liquid.

A rubber roller 50 is disposed so as to press-contact the gravure roller 48. The rubber roller 50 contacts the recording surface (obverse) side of the sheet and coats the processing liquid thereon. Further, a squeegee (not shown) contacts the gravure roller 48 and controls the processing liquid coating amount that is coated on the recording surface of the sheet.

The film thickness of the processing liquid may be made to be sufficiently smaller than the ink drop ejected by the head. For example, if the ejected amount is 2 pl, the average diameter of the ink drop ejected by the head is 15.6 μm. If the film thickness of the processing liquid is thick, the ink dot floats within the processing liquid without contacting the recording surface of the sheet. The film thickness of the processing liquid may be made to be less than or equal to 3 μm in order to obtain a landed dot diameter of greater than or equal to 30 μm by an ejected amount of 2 pl.

On the other hand, at the processing liquid drying device 44, a hot air nozzle 54 and an infrared heater 56 (hereinafter called “IR heater 56”) are disposed near to the surface of the processing liquid coating drum 30. The solvent such as water or the like within the processing liquid is vaporized by the hot air nozzle 54 and the IR heater 56, and a solid or thin-film processing liquid layer is formed on the recording surface side of the sheet. By making the processing liquid be a thin layer in the processing liquid drying process, the dots formed by ink ejection at the image forming section 16 contact the sheet surface such that the necessary dot diameter is obtained, and the actions of reacting with the processing liquid that has been made into a thin layer, aggregating the color material, and fixing to the sheet surface are easily obtained.

The sheet, on whose recording surface the processing liquid has been coated and dried at the processing liquid coating section 14 in this way, is conveyed to an intermediate conveying section 58 that is provided between the processing liquid coating section 14 and the image forming section 16.

(Intermediate Conveying Section)

The intermediate conveying drum 34 is provided at the intermediate conveying section 58 so as to be rotatable. The intermediate conveying section 58 holds the sheet at the surface of the intermediate conveying drum 34 via the holding member 32 provided at the intermediate conveying drum 34, and conveys the sheet to the downstream side by the rotation of the intermediate conveying drum 34.

(Image Forming Section)

The image forming drum 36 is provided at the image forming section 16 so as to be rotatable. The image forming section 16 holds the sheet at the surface of the image forming drum 36 via the holding member 32 provided at the image forming drum 36, and conveys the sheet to the downstream side by the rotation of the image forming drum 36.

Head units 66, that have single-pass inkjet line heads 64 (hereinafter called “heads 64”) at which plural nozzles that eject ink drops respectively are provided in a two-dimensional form, are disposed at the upper portion of the image forming drum 36 so as to be near the surface of the image forming drum 36. At the head units 66, the heads 64 of at least Y (yellow), M (magenta), C (cyan), K (black) that are basic colors are arrayed along the peripheral direction of the image forming drum 36. The head units 66 form images of the respective colors on the processing liquid layer that was formed on the recording surface of the sheet at the processing liquid coating section 14.

The color material (pigment) and the latex particles, that are dispersed within the ink, aggregate in the processing liquid, and form aggregates at which flowing of the color material and the like do not occur on the sheet. As an example of the reaction between the ink and the processing liquid, by using a mechanism in which pigment dispersion is destroyed and aggregates are formed by including an acid within the processing liquid and lowering the pH, running of the color material, color mixing between the inks of the respective colors, and droplet interference due to uniting of liquids at the time when the ink drops land are avoided.

The heads 64 carry out ejecting synchronously with an encoder (not illustrated) that is disposed at the image forming drum 36 and detects the rotating speed. Due thereto, the landing positions are determined highly accurately, and droplet patches can be reduced independently of deviations of the image forming drum 36, the precision of a rotating shaft 68, and the surface speed of the drum.

Note that the head units 66 can be withdrawn from the upper portion of the image forming drum 36. Maintenance operations such as cleaning of the nozzle surfaces of the heads 64, expelling of ink whose viscosity has increased, and the like are carried out by withdrawing the head units 66 from the upper portion of the image forming drum 36.

Due to the rotation of the image forming drum 36, the sheet, on whose recording surface an image is formed, is conveyed to an intermediate conveying section 70 that is provided between the image forming section 16 and the ink drying section 18. However, because the structure of the intermediate conveying section 70 is substantially the same as that of the intermediate conveying section 58, description thereof is omitted.

(Ink Drying Section)

The ink drying drum 38 is provided at the ink drying section 18 so as to be rotatable. Plural hot air nozzles 72 and IR heaters 74 are disposed at the upper portion of the ink drying drum 38 so as to be near the surface of the ink drying drum 38. Due to the warm air from the hot air nozzles 72 and the IR heaters 74, at the portions of the sheet where the image is formed, the solvent that was separated by the color material aggregating action is dried, and a thin-film image layer is formed.

The warm air is usually set to 50° C. to 70° C., although it differs in accordance with the conveying speed of the sheet as well. The evaporated solvent is discharged to the exterior of the image forming device 10 together with air. However, the air is recovered. This air may be cooled by a cooler/radiator or the like, and recovered as liquid.

Due to the rotation of the ink drying drum 38, the sheet, on whose recording surface the image is dried, is conveyed to an intermediate conveying section 76 that is provided between the ink drying section 18 and the image fixing section 20. Because the structure of the intermediate conveying section 76 is substantially the same as that of the intermediate conveying section 58, description thereof is omitted.

(Image Fixing Section)

The image fixing drum 40 is provided at the image fixing section 20 so as to be rotatable. At the image fixing section 20, the latex particles within the image layer, that is a thin layer that was formed on the ink drying drum 38, are subjected to heat and pressure and are fused, and are fixed on the sheet.

A heating roller 78 is disposed at the upper portion of the image fixing drum 40 so as to be near the surface of the image fixing drum 40. At the heating roller 78, a halogen lamp is built-in within a metal pipe of aluminum or the like that has good thermal conductivity, and thermal energy of greater than or equal to the Tg temperature of the latex is provided by the heating roller 78. Due thereto, the latex particles fuse and push-in fixing into the indentations and protrusions on the sheet is carried out, and the unevenness of the surface of the image is leveled and glossiness is obtained.

A fixing roller 80 is provided at the downstream side of the heating roller 78. The fixing roller 80 is disposed in a state of press-contacting the surface of the image fixing drum 40, and nipping force is obtained between the fixing roller 80 and the image fixing drum 40. Therefore, at least one of the fixing roller 80 and the image fixing drum 40 has an elastic layer at the surface thereof, and has a uniform nip width with respect to the sheet.

The sheet, on whose recording surface an image is fixed by the above-described processes, is conveyed by the rotation of the image fixing drum 40 toward the discharging section 21 that is provided at the downstream side of the image fixing section 20.

Note that, although the image fixing section 20 is described in the present exemplary embodiment, it suffices to be able to, at the ink drying section 18, dry and fix the image that is formed on the recording surface. Therefore, the image fixing section 20 is not absolutely necessary.

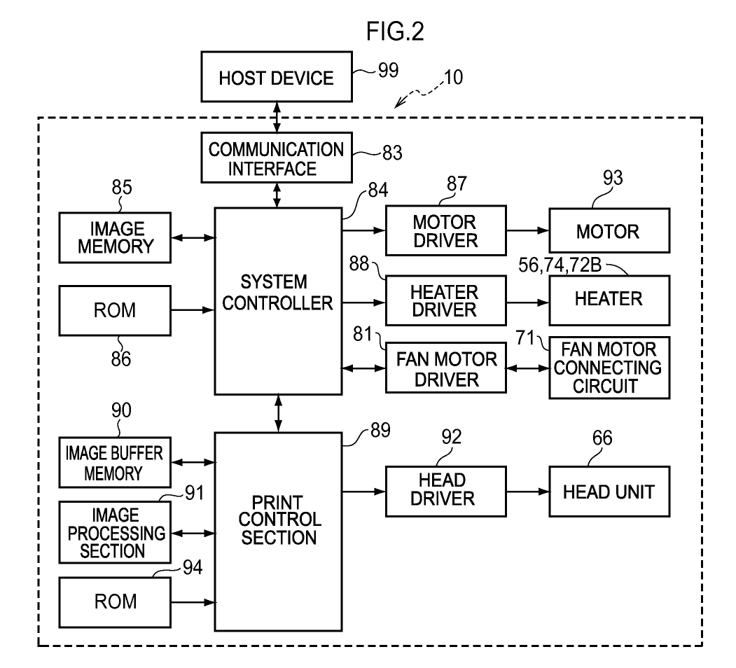

The system structure of the image forming device 10 relating to the present exemplary embodiment will be described next with reference to FIG. 2.

As shown in FIG. 2, the image forming device has a communication interface 83, a system controller 84, an image memory 85, a ROM 86, a motor driver 87, a heater driver 88, a fan motor driver 81, a print control section 89, an image buffer memory 90, an image processing section 91, a head driver 92, and the like.

The communication interface 83 is an interface section with a host device 99 that a user uses for carrying out instruction of image formation and the like with respect to the image forming device 10. A serial interface such as a USB (Universal Serial Bus), IEEE 1394, an ETHERNET®, a wireless network or the like, or a parallel interface such as centronics or the like, can be used as the communication interface 83. A buffer memory (not illustrated) for making the communication be high-speed may be installed in this portion.

Image data sent-out from the host device 99 is fetched by the image forming device 10 via the communication interface 83, and is once stored in the image memory 85. The image memory 85 is a storage unit that stores image data that has been inputted via the communication interface 83. Reading and writing of information from and to the image memory 85 are carried out through the system controller 84. The image memory 85 is not limited to a memory formed from a semiconductor element, and a magnetic medium such as a hard disk or the like may be used.

The system controller 84 is structured by a central processing unit (CPU), peripheral circuits thereof, and the like. The system controller 84 functions as a control device that controls the overall image forming device 10 in accordance with predetermined programs, and functions as a computing device that carries out various types of computation. Namely, the system controller 84 controls respective sections such as the communication interface 83, the image memory 85, the motor driver 87, the heater driver 88, the fan motor driver 81, and the like, and carries out control of communication with the host device 99, control of reading and writing from and to the image memory 85 and the ROM 86, and the like, and generates control signals that control motors 93 of the sheet conveying system and the IR heaters 56, 74, 72. Note that, in addition to control signals, the system controller 84 transmits image data that is stored in the image memory 85 to the print control section 89.

Programs that the CPU of the system controller 84 executes, various types of data that are needed for control, and the like are stored in the ROM 86. The ROM 86 may be a non-rewritable storage unit. However, if the various types of data are updated as needed, a rewritable storage unit such as an EEPROM may be used in place of ROM 86.

The image memory 85 is used as a temporary storage region of image data, and is also used as a region in which a program is expanded for execution and as a computing work region of the CPU.

The motor driver 87 is a driver (driving circuit) that drives the motors 93 of the sheet conveying system in accordance with instructions from the system controller 84. Further, the heater driver 88 is a driver that drives the IR heaters 56, 74, 72 in accordance with instructions from the system controller 84.

The fan motor driver 81 is a driver that drives respective fan motors 73 and a fan motor connecting circuit 71 in accordance with instructions from the system controller 84.

On the other hand, the print control section 89 is structured from a CPU, peripheral circuits thereof, and the like. In accordance with control of the system controller 84, the print control section 89 carries out, in cooperation with the image processing section 91, processings such as various types of manipulations, corrections and the like for generating signals for ejection control from the image data within the image memory 85, and supplies generated ink ejection data to the head driver 92 so as to control the ejection driving of the head units 66.

A ROM 94, in which are stored programs that the CPU of the print control section 89 executes and various types of data needed for control and the like, is connected to the print control section 89. The ROM 94 may be a non-rewritable storage unit. However, if the various types of data are updated as needed, a rewritable storage unit such as an EEPROM may be used in place of the ROM 94.

The image processing section 91 generates dot placement data per ink color from the inputted image data. The image processing section 91 carries out halftone processing (intermediate gradation processing) on inputted image data, and determines high-quality dot positions.

Note that, in FIG. 2, the image processing section 91 is illustrated as being a structure separate from the system controller 84 and the print control section 89. However, for example, the image processing section 91 may be included in the system controller 84 or the print control section 89 and may structure a portion thereof.

Further, the print control section 89 has an ink ejection data generating function that generates ejection data of the ink (control signals of the actuators corresponding to the nozzles of the heads 64) on the basis of the dot placement data generated at the image processing section 91, and has a driving waveform generating function. Accordingly, the print control section 89 generates waveform signals expressing driving waveforms that are used at the time of ejecting ink drops from the heads 64.

The ink ejection data generated by the ink ejection data generating function is provided to the head driver 92, and the ink ejecting operations of the head units 66 are controlled.

The driving waveform generating function is a function that generates driving signal waveforms for driving the actuators corresponding to the respective nozzles of the heads 64. The signals (driving waveforms) that are generated by this driving waveform generating function are supplied to the head driver 92. Note that the signals that are generated by the driving waveform generating function may be digital waveform data, or may be analog voltage signals. The head driver 92 supplies the generated waveform signals to the heads 64, and causes ink drops to be ejected.

The image buffer memory 90 is provided at the print control section 89. Data such as image data, parameters and the like at the time of image data processing at the print control section 89 are temporarily stored in the image buffer memory 90. Note that FIG. 2 illustrates a form in which the image buffer memory 90 is appended to the print control section 89. However, the image buffer memory 90 may also serve as the image memory 85.

Note that the print control section 89 and the system controller 84 may be consolidated and structured by a single processor.

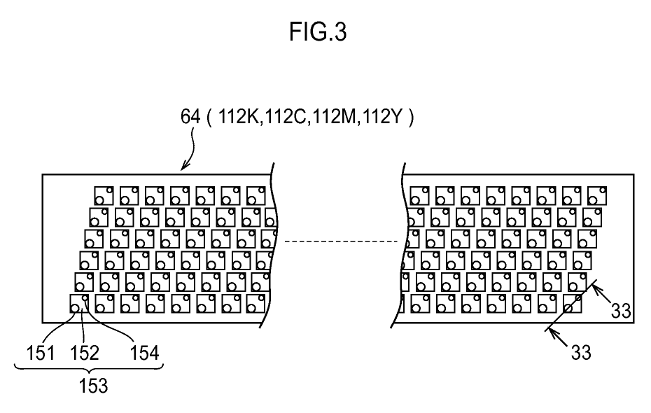

FIG. 3 is a transparent plan view showing a structural example of the head 64. In order to realize a high-density dot pitch on the printed sheet, the nozzle pitch at the head 64 must have a high-density. At the head 64 of the present example, plural ink chamber units (droplet ejecting elements) 153, that are formed from nozzles 151 that are ink ejecting openings, pressure chambers 152 corresponding to the respective nozzles 151, and the like, are disposed so as to be staggered and in the form of a matrix (two-dimensionally). Due thereto, a high density of the substantial nozzle interval (projected nozzle pitch) that is projected so as to be lined-up along the head longitudinal direction (a direction orthogonal to the sheet feeding direction) is achieved.

In this way, at the head 64, the plural nozzles 151 that eject ink drops are lined-up in the conveying direction of the sheet on which the ink drops are to be ejected, and in a cross-conveying direction that crosses the conveying direction.

Note that a form, in which one or more nozzle rows are structured along a length corresponding to the entire width of the sheet in a direction crossing the conveying direction, is not limited to the present example.

The shapes, in plan view, of the pressure chambers 152 that are provided so as to correspond to the respective nozzles 151 are substantially square. A flow-out opening to the nozzle 151 is provided at one of the both corner portions on a diagonal line of the pressure chamber 152, and a flow-in opening (supply opening) 154 of the supplied ink is provided at the other. Note that the shape of the pressure chambers 152 in plan view may be any of various forms such as quadrangular (rhomboid, rectangular, or the like), pentagonal, hexagonal, another polygonal shape, circular, oval or the like.

The respective pressure chambers 152 communicate with a common flow path via the supply openings 154. The common flow path communicates with an ink tank (not shown) that is the ink supply source. Ink supplied from the ink tank is distributed and supplied to the respective pressure chambers 152 via the common flow path.

An actuator having an individual electrode is joined to a pressure-applying plate (a vibrating plate that also serves as a common electrode) that structures the surface of a portion of the pressure chamber 152. By applying driving voltage between the individual electrode and the common electrode, the actuator deforms, the volume of the pressure chamber changes, and, due to the change in pressure accompanying this, ink is ejected from the nozzle 151. Note that a piezoelectric element using a piezoelectric body such as lead zirconate titanate, barium titanate, or the like may be used as the actuator.

After the ejecting of the ink, when the displacement of the actuator returns to the original state, new ink is replenished to the pressure chamber 152 through the supply opening 154 from the common flow path.

The driving of the actuators corresponding to the respective nozzles 151 is controlled in accordance with the dot placement data generated from the image data Ink drops can thereby be ejected from the nozzles 151.

The arranged structure of the nozzles when implementing the present invention is not limited to the illustrated example. Further, in the present exemplary embodiment, a method is employed of ejecting ink drops by deformation of actuators that are exemplified by piezo elements (piezoelectric elements). However, when implementing the present invention, the method of ejecting ink is not particularly limited. Instead of a piezo jetting method, any of various types of methods can be applied such as a thermal jetting method in which the ink is heated by a heat-generating body such as a heater or the like such that air bubbles are generated, and ink drops are ejected due to the pressure thereof, or the like.

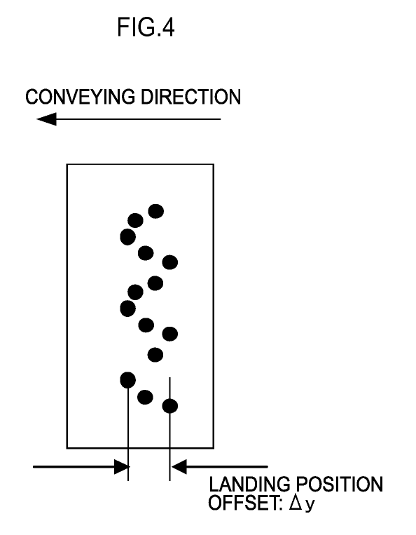

Offset of the landing positions will be described next. When ink drops are ejected from the nozzles 151 of the head 64 at timings with respect to a sheet that is conveyed at a flat conveying path in order to draw a straight line in an cross-conveying direction, offset arises in the landing positions in the conveying direction as shown in FIG. 4, because the image forming drum 36 (simply called “drum 36” hereinafter) is curved with respect to the head 64.

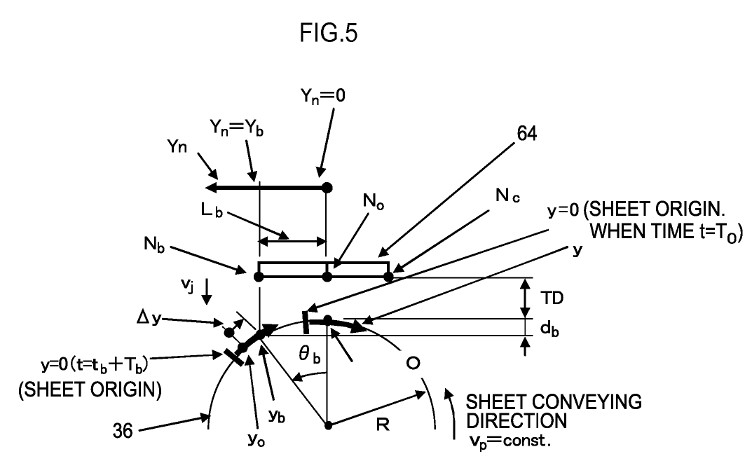

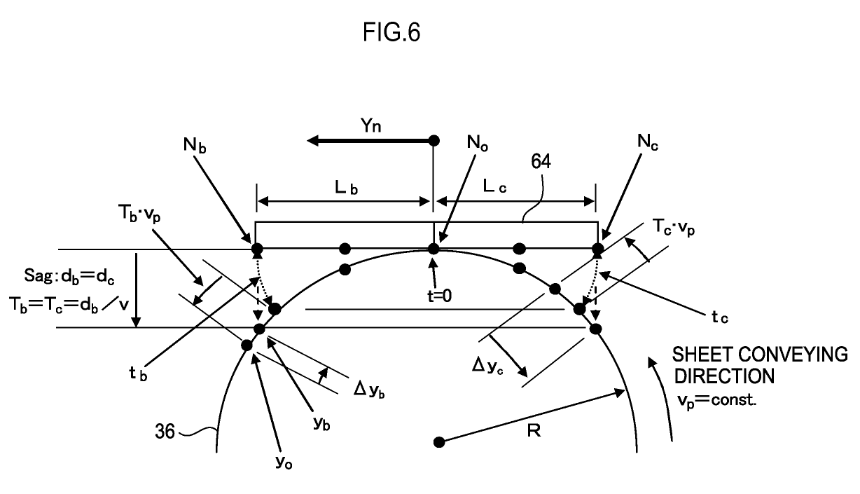

This offset will be described in detail. FIG. 5 and FIG. 6 are drawings showing the positional relationship of the head 64 and the drum 36. In particular, FIG. 6 is a drawing in which the width of the head 64 is made to be large in order to facilitate understanding.

In FIG. 5, the barrel peak of the drum 36 is O, and the nozzle on the head 64 that is nearest to O is N₀. The distance between the nozzle N₀ and O is TD (Throw Distance). Note that the thickness of the sheet is disregarded.

The coordinates of the nozzles on the head 64 are expressed by one-dimensional coordinates Yₙ in the conveying direction. The coordinate of the nozzle N₀ is 0, and the nozzles that are positioned in the conveying direction from the nozzle N₀ are N_{b}, N_{c}. In particular, the distance of the nozzle N_{b}, that is positioned at the downstream side of the nozzle N₀, with respect to the nozzle N₀ is L_{b}, and the coordinate of N_{b} is Y_{b}.

The coordinates on the sheet will be described next. The coordinates of the sheet also are expressed by one-dimensional coordinates y in the conveying direction, and the origin y=0 is positioned at the barrel peak O at time t=0. The sheet is conveyed counterclockwise, and the conveying speed is vₚ. Further, the ejecting speed of the ink drop (hereinafter called droplet speed) is vⱼ. The barrel radius, that is the radius of the drum 36, is R.

Based on the above, first, a landing position y₀ of an ink drop D₀ ejected from the nozzle N₀ will be described. Flying time T₀ of the ink drop is the value expressed by equation 2.

T₀=TD/vⱼ (2)

Accordingly, the landing position coordinate y₀ is the distance that the sheet advances during this time, and is the value expressed by equation 3.

y₀=T₀vₚ=TDvₚ/vⱼ (3)

Next, a landing position y_{b} of an ink drop D_{b} ejected from the nozzle N_{b} will be described. The ink drop D_{b} is ejected after time t_{b} that is determined by the distance L_{b} (=Y_{b}) between the nozzle N₀ and the nozzle N_{b} and the conveying speed vₚ. Accordingly, the time t_{b} is the value expressed by equation 4, and this value is constant.

t_{b}=L_{b}/vₚ=Y_{b}/vₚ=const. (4)

Further, given that the sag, that is the value obtained by subtracting aforementioned TD from the length of the locus over which the ink drop D_{b}, that is ejected from the nozzle N_{b}, falls to the drum 36, is d_{b}, flying time T_{b} of the ink drop D_{b} is the value expressed by equation 5.

T_{b}=(TD+d_{b})/vⱼ (5)

Here, the sag d_{b} is the value expressed by equation 6, from the barrel radius R and Y_{b}.

d_{b}=R(1−cos θ_{b})=R(1−cos(sin⁻¹(Y_{b}/R))) (6)

The ink drop D_{b} lands after the time t_{b} expressed by above equation 4 and the time expressed by above equation 5 have elapsed. Therefore, distance S_{b0}, over which the sheet moves during this time, is the value expressed by equation 7.

S_{b0}=(t_{b}+T_{b})vₚ (7)

On the other hand, distance S_{b} between the landing position of the ink drop D_{b} and O is the value expressed by equation 8.

S_{b}=Rθ_{b}=R sin⁻¹(Y_{b}/R) (8)

From above equation 7 and equation 8, the coordinate y_{b} on the sheet of the landing position of the ink drop D_{b} is the value expressed by equation 9.

$$\begin{matrix}{y}_{b} = {S}_{b 0} - {S}_{b} \\ = ( {t}_{b} + {T}_{b} ) {v}_{p} - R {sin}^{- 1} ( {Y}_{b} / R ) \\ = ( {t}_{b} + ( TD + {d}_{b} ) / {v}_{j} ) {v}_{p} - R {sin}^{- 1} ( {Y}_{b} / R )\end{matrix} \qquad ( 9 )$$

Accordingly, offset Δy_{b} (see FIG. 6) of the landing position is the difference between the coordinate y_{b} and the coordinate y₀. Therefore, from equation 3 and equation 9, Δy_{b} is the value expressed by equation 10.

$$\begin{matrix}Δ {y}_{b} = {y}_{b} - {y}_{0} \\ = ( {t}_{b} + ( TD + {d}_{b} ) / {v}_{j} ) {v}_{p} - R {sin}^{- 1} ( {Y}_{b} / R ) - {TDv}_{p} / {v}_{j} \\ = ( {t}_{b} + {d}_{b} / {v}_{j} ) {v}_{p} - R {sin}^{- 1} ( {Y}_{b} / R ) \\ = ( {t}_{b} + R ( 1 - cos ( {sin}^{- 1} ( {Y}_{b} / R ) ) ) / {v}_{j} ) {v}_{p} - R {sin}^{- 1} ( {Y}_{b} / R ) \\ = {t}_{b} {v}_{p} - R {sin}^{- 1} ( {Y}_{b} / R ) + R ( 1 - cos ( {sin}^{- 1} ( {Y}_{b} / R ) ) ) {v}_{p} / {v}_{j}\end{matrix} \qquad ( 10 )$$

Because the first term is dependent on time t_{b}, this shows that it is due to the timing at which the ink drop is ejected. Further, because the second term is dependent on the radius R, this shows that it is due to the extent of curving of the drum 36. Moreover, because the third term is dependent on the distance of the sag and on the droplet speed vⱼ, this shows that it is due to the flying time corresponding to the distance of the sag.

The above is the offset of the landing position of the ink drop D_{b} that is ejected from the nozzle N_{b} positioned at the downstream side of the nozzle N₀. Next, the offset of landing position y_{c} of ink drop D_{c}, that is ejected from the nozzle N_{c} positioned at the upstream side of the nozzle N₀, will be described.

The ink drop D_{c} is ejected before a time that is determined by distance L_{c} between the nozzle N₀ and the nozzle N_{c}, and the conveying speed vₚ. The coordinate at which the nozzle N_{c} is positioned is Y_{c} (<0), and Y_{c} is equal to −L_{c}. Further, the time at which the origin of the sheet is positioned at O is 0. Accordingly, time t_{c} that the ink drop D_{c} is ejected from the nozzle N_{c} is the value expressed by equation 11, and this value is constant.

t_{c}=−L_{c}/vₚ=Y_{c}/vₚ=const.(<0) (11)

Further, given that the sag, that is the value obtained by subtracting aforementioned TD from the distance of the locus over which the ink drop D_{c}, that is ejected from the nozzle N_{c}, falls to the drum 36, is d_{c}, flying time T_{c} of the ink drop D_{c} is the value expressed by equation 12.

T_{c}=(TD+d_{c})/vⱼ (12)

Here, the sag d_{c} is the value expressed by equation 13, from the barrel radius R and Y_{c}.

d_{c}=R(1−cos θ_{c})=R(1−cos(sin⁻¹(Y_{c}/R))) (13)

The ink drop D_{c} lands after the time t_{c} expressed by above equation 11 and the time T_{c} expressed by above equation 12 have elapsed. Therefore, distance S_{c0}, over which the sheet moves during this time, is the value expressed by equation 14.

S_{c0}=(t_{c}+T_{c})vₚ (14)

On the other hand, distance S_{c} between the landing position of the ink drop D_{c} and O is the value expressed by equation 15.

S_{c}=−Rθ_{c}=R sin⁻¹(Y_{c}/R) (15)

From above equation 14 and equation 15, the coordinate y_{c} on the sheet of the landing position of the ink drop D_{c} is the value expressed by equation 16.

y_{c}=S_{c0}−S_{c}=(t_{c}+T_{c})vₚ−R sin⁻¹(Y_{c}/R)=(t_{c}+(TD+d_{c})/vⱼ)vₚ−R sin⁻¹(Y_{c}/R) (16)

Accordingly, offset Δy_{c} (see FIG. 6) of the landing position is the difference between the coordinate y_{c} and the coordinate y₀. Therefore, from equation 3 and equation 16, Δy_{c} is the value expressed by equation 17.

$$\begin{matrix}Δ {y}_{c} = {y}_{c} - {y}_{0} \\ = ( {t}_{c} + ( TD + {d}_{c} ) / {v}_{j} ) {v}_{p} - R {sin}^{- 1} ( {Y}_{c} / R ) - {TDv}_{p} / {v}_{j} \\ = ( {t}_{c} + {d}_{c} / {v}_{j} ) {v}_{p} - R {sin}^{- 1} ( {Y}_{c} / R ) \\ = ( {t}_{c} + R ( 1 - cos ( {sin}^{- 1} ( {Y}_{c} / R ) ) ) / {v}_{j} ) {v}_{p} - R {sin}^{- 1} ( {Y}_{c} / R ) \\ = {t}_{c} {v}_{p} - R {sin}^{- 1} ( {Y}_{c} / R ) + R ( 1 - cos ( {sin}^{- 1} ( {Y}_{c} / R ) ) ) {v}_{p} / {v}_{j}\end{matrix} \qquad ( 17 )$$

Equation 17 is, in form, the same as the equations expressed by equation 10. It suffices to determine the respective parameters such that Δy_{b} and Δy_{c} that are determined in this way become 0. Δy_{b} and Δy_{c} are, in form, the same equation. Accordingly, computation is carried out by using Δy_{b} expressed by equation 9 as a representative example.

First, in equation 10, as described above, the first term is dependent on time t_{b}, the second term is dependent on the radius R, and the third term is dependent on the distance of the sag and on the droplet speed vⱼ. Further, time t_{b} that is the ejection timing does not change. Therefore, as shown in equation 17, the Y_{b} of the second and third terms are replaced by Y′_{b}, and a value such that Δy_{b} becomes 0 is determined.

Y′_{b} that satisfies

Δy_{b}=t_{b}vₚ−R sin⁻¹(Y′_{b}/R)+R(1−cos(sin⁻¹(Y′_{b}/R)))vₚ/vⱼ=0 (18)

is derived.

Note that

θ′_{b}=sin⁻¹(Y′_{b}/R) (19)

and Δy_{b} may be derived as

Δy_{b}=t_{b}vₚ−Rθ′_{b}+R(1−cos θ′_{b})vₚ/vⱼ=0 (20)

Similar computation can be carried out in the case of Δy_{c} as well. The Y′_{b} that is derived here is a coordinate (distance) that is determined in accordance with the timing t_{b} at which the nozzle 151 ejects the ink drop, the ejection speed vⱼ of the ink drop, the conveying speed vₚ of the sheet, and the radius R of the drum 36.

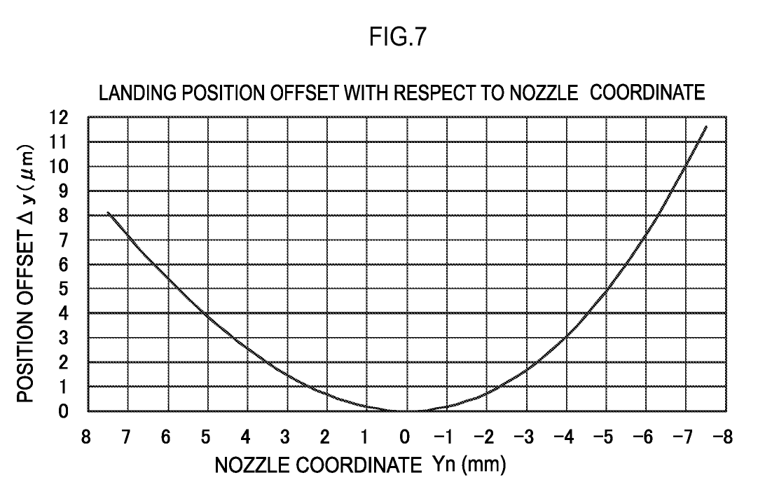

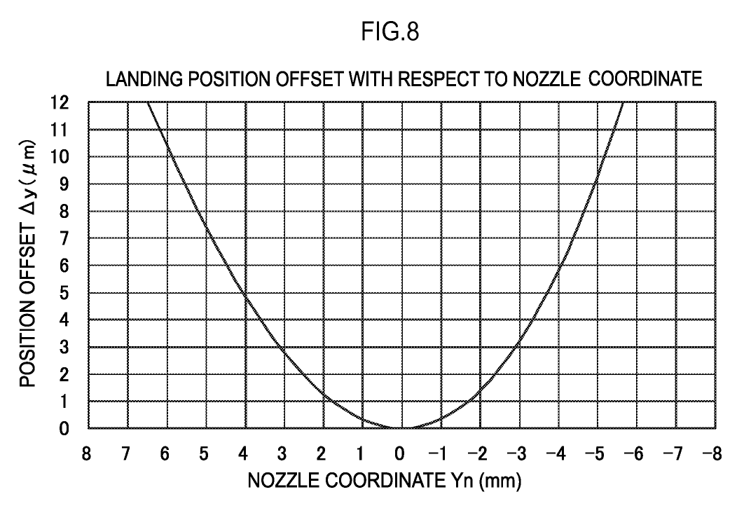

Examples of above-described Δy_{b} and Δy_{c} will be shown by using FIG. 7 and FIG. 8. In the graphs shown in FIG. 7 and FIG. 8, the horizontal axis is the nozzle coordinates, and the vertical axis is Δy. Note that Δy is expressed by gathering together data in which Δy is Δy_{c} when the nozzle coordinate is negative, and Δy is Δy_{b} when the nozzle coordinate is greater than or equal to 0.

The graph shown in FIG. 7 shows the position offset when the barrel radius R is 200 mm, the conveying speed vₚ is 700 mm/s, and the droplet speed vⱼ is 10 m/s. On the other hand, the graph shown in FIG. 8 shows the position offset when the barrel radius R is 150 mm, the conveying speed vₚ is 1000 mm/s, and the droplet speed vⱼ is 10 m/s.

As can be understood from these graphs, the smaller the barrel radius R, the greater the position offset, and further, the faster the conveying speed, the greater the position offset. Accordingly, position offset becomes particularly problematic when the device is made to be compact or high-speed.

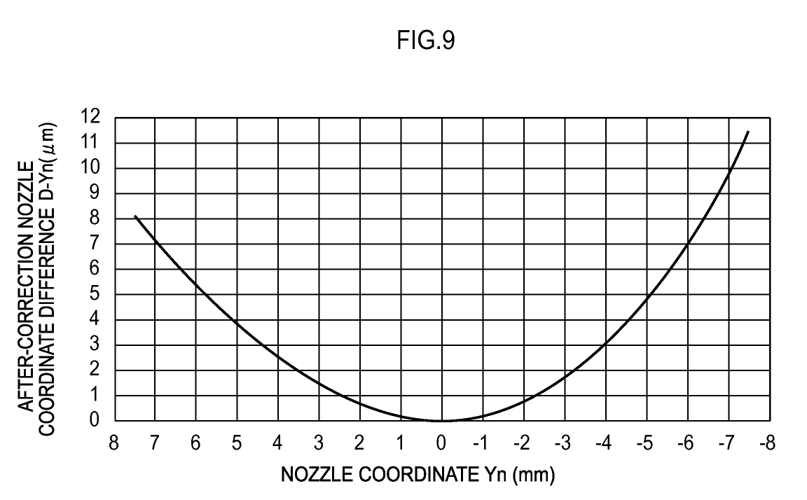

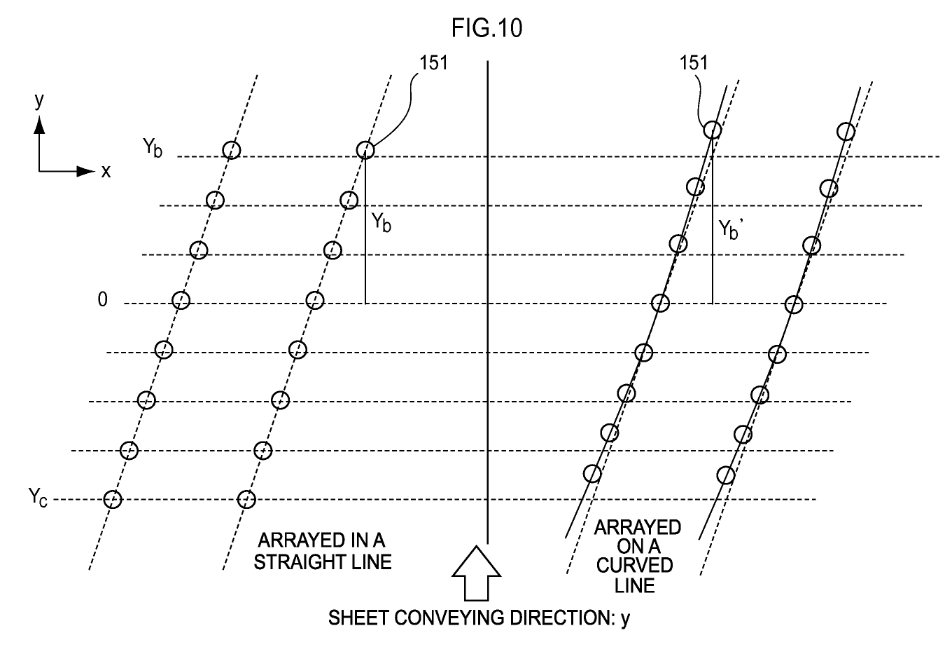

The graph shown in FIG. 9 shows after-correction nozzle coordinate differences that are derived under the conditions shown in FIG. 7 (the barrel radius R is 200 mm, the conveying speed vₚ is 700 mm/s, and the droplet speed vⱼ is 10 m/s). The after-correction nozzle coordinate difference will be explained by using FIG. 10. FIG. 10 shows the nozzles 151 that are disposed rectilinearly, and the respective nozzles 151 that are disposed in accordance with the coordinates (distances) Y′_{b} that are determined by equation 18. The after-correction nozzle coordinate difference shows how much a nozzle has moved in the conveying direction from the original nozzle coordinate Y_{b} shown in FIG. 10.

As shown in the graph of FIG. 9, the greater the absolute value of the nozzle coordinate, the more the after-correction nozzle coordinate difference increases. Therefore, as shown by coordinate (distance) Y′_{b} of FIG. 10, this is an arrangement in which, the larger the absolute value of the nozzle coordinate of the nozzle 151, the more that the nozzle 151 is offset in the conveying direction from its original position. Namely, the ejecting openings are arrayed in accordance with these distances such that the positions, in the conveying direction of the sheet at which the droplets land in accordance with this arrangement, substantially coincide at all of the nozzles. Accordingly, offset of the landing positions of the ink drops can be suppressed without forming the ejection surface in the form of a curved surface.

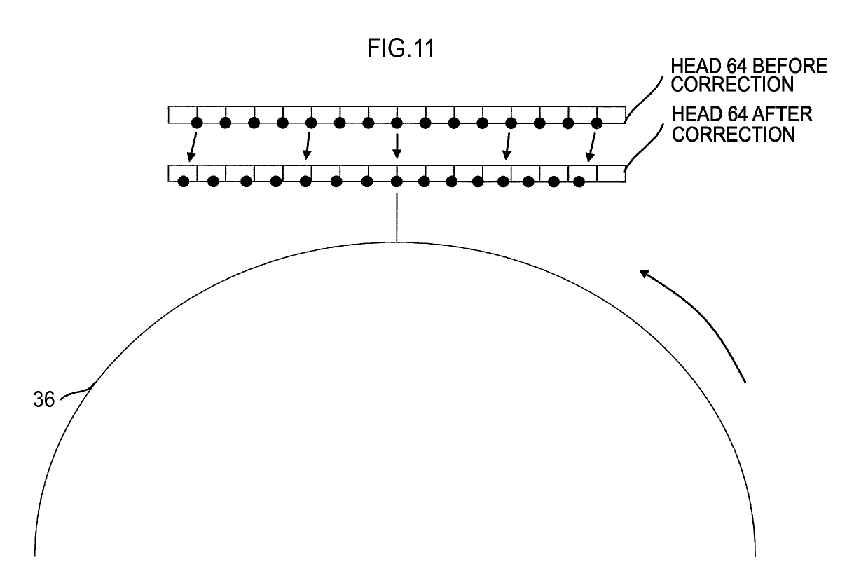

FIG. 11 is a drawing showing the positional relationship of the head 64 and the drum 36 before correction and after correction. The nozzles 151 are disposed on grid points of a pitch that is determined from the image-drawing resolution, as shown by the rectilinear arrangement in FIG. 10. However, after correction, the nozzles 151 are disposed on grid points that are dense at the sheet conveying direction upstream side and are sparse at the downstream side, from the point of tangency with the curved surface of the drum 36. In other words, the nozzles after correction are offset from grid points of a uniform pitch, and the positions thereof are offset such that, the further away from the point of tangency with the curved surface, the more the position is offset toward the sheet conveying direction downstream side.

In accordance with the above-described aspect of the present invention, the ejecting openings are disposed in accordance with the aforementioned distances such that the positions, in the conveying direction of the recording medium on which the droplets land, substantially coincide at all of the ejecting openings. Therefore, there can be provided a droplet ejecting head that suppresses offset in the landing positions of droplets, without forming the ejection surface in the shape of a curved surface.

Further, in the above-described aspect, the distance Y′_{b} may be determined by the following equation:

t_{b}vₚ−R sin⁻¹(Y′_{b}/R)+R(1−cos(sin⁻¹(Y′_{b}/R)))vₚ/vⱼ=0 (1)

where

t_{b}: ejection timing,

vⱼ: ejecting speed of droplets,

vₚ: conveying speed,

R: radius of drum.

Another aspect of the present invention is an image forming device having: the droplet ejecting head of the previously described aspect; the conveying unit; a waveform signal generating unit that generates waveform signals that are used when the droplet ejecting head ejects droplets; and a supplying unit that supplies, to the droplet ejecting head, the waveform signals that are generated by the waveform signal generating unit.

In accordance with the above-described aspect of the present invention, the ejecting openings are disposed in accordance with the aforementioned distances such that the positions, in the conveying direction of the recording medium on which the droplets land, substantially coincide at all of the ejecting openings. Therefore, there can be provided an image forming device that suppresses offset in the landing positions of droplets, without forming the ejection surface in the shape of a curved surface. Further, because there is no need to change the ejection timings, offset can be suppressed by replacing only the droplet ejecting head.

Further, there can be provided a droplet ejecting head and an image forming device that suppress offset in the landing positions of droplets, without forming an ejection surface in the shape of a curved surface.

What is claimed is:

1. A droplet ejecting head that ejects droplets onto a recording medium that is conveyed by a conveying unit that conveys the recording medium while causing the recording medium to closely contact a peripheral surface of a drum, the droplet ejecting head comprising:
a plurality of ejecting openings that are provided so as to be lined-up in a conveying direction of the recording medium onto which the droplets are ejected, and in an cross-conveying direction that crosses the conveying direction,
wherein distances, in the conveying direction of the recording medium, of the respective ejecting openings are determined in accordance with timings at which the respective ejecting openings eject the droplets, an ejecting speed of the droplets, a conveying speed of the recording medium, and a radius of the drum, such that positions, along the conveying direction of the recording medium, at which the droplets ejected from the ejecting openings land, substantially coincide at all of the ejecting openings.

2. The droplet ejecting head of claim 1, wherein the distances, in the conveying direction of the recording medium, of the respective ejecting openings are determined such that, the plurality of ejecting openings are disposed on grid points that are dense at the sheet conveying direction upstream side and are sparse at the downstream side.

3. The droplet ejecting head of claim 1, wherein the distance Y′_{b}, in the conveying direction of the recording medium, of the respective ejecting openings is determined by the following equation:
t_{b}vₚ−R sin⁻¹(Y′_{b}/R)+R(1−cos(sin⁻¹(Y′_{b}/R)))vₚ/vⱼ=0 (1)
where
t_{b}: ejection timing
vⱼ: ejecting speed of droplets
vₚ: conveying speed
R: radius of drum.

4. An image forming device comprising:
the droplet ejecting head of claim 1;
the conveying unit;
a waveform signal generating unit that generates waveform signals that are used when the droplet ejecting head ejects droplets; and
a supplying unit that supplies, to the droplet ejecting head, the waveform signals that are generated by the waveform signal generating unit.
